(19) United States
(12) Patent Application Publication
(10) Pub. No.: US 2004/0111518 A1
(43) Pub. Date: Jun. 10, 2004

(54) Portability of computer system resources using transferable profile information

(76) Inventor: Marc P. Schuyler, Mountain View, CA (US)

Correspondence Address: HEWLETT-PACKARD COMPANY, Intellectual Property Administration, P.O. Box 272400, Fort Collins, CO, 80527-2400, US

(21) Appl. No.: 10/314,025

(22) Filed: Dec. 5, 2002

(51) Int. Cl. G06F 15/177; G06F 15/16; G09G 5/00

(52) U.S. Cl. 709/228; 709/220; 345/762

(57) ABSTRACT

Methods and devices providing portability of computer resources are described. Profile information associated with a user is received. The profile information is for configuring a device in a configuration particular to the user. The profile information is transferable to different devices, so that the configuration is substantially reproducible on the different devices. Access to selected software resident on the device is permitted according to the profile information. Access to other, selected software not resident on the device but residing on a source external to the device is also permitted according to the profile information.

### TECHNICAL FIELD

Embodiments of the present invention relate to the field of computer systems. More specifically, embodiments of the present invention relate to methods and devices that provide portability of computer system resources.

### BACKGROUND ART

Innovations in information technology (IT) have profoundly affected how people use computers. For example, the widespread proliferation of computers has prompted the development of computer system networks that allow computers to communicate with each other.

Other innovations include the introduction of laptop and notebook computer systems. By virtue of their smaller size and lighter weight, laptops and notebooks provide substantial computing power in portable form. However, relative to conventional desktop computer systems, laptops and notebooks are more expensive. In addition, there is likely a limit as to how small and light these types of computer systems can get. For example, keyboards and displays that are of an adequate size can govern how small such devices may be.

Hand-hand devices (e.g., personal digital assistants and even cell phones) are smaller in size and weight than laptops and notebooks, but also provide comparatively limited computational resources. In addition, hand-helds have some disadvantages compared to desktops, such as small screen sizes and miniature keyboards.

Eventually, the computing power of laptops/notebooks and the size/weight of hand-helds may meet in a single device. Still, such a device will have a number of disadvantages relative to desktops. For example, even with high resolution and brilliant colors, the display of such a device will likely suffer in comparison to the display provided by a conventional desktop computer monitor. Thus, while there are advantages to portable computer systems, there are also some trade-offs relative to desktops.

Another disadvantage to portable devices, and even with desktop computer systems, is the difficulty in gaining remote access to items stored in memory on a local computer system. Consider, for example, a user who has a laptop computer system that is used while traveling, and a desktop computer system that remains at home or in the office. The user, while remotely located and in use of the laptop, may desire access to information stored on the hard drive of the desktop. This situation is one that computer technologists have long labored to address.

There are solutions in place that address this problem, and other solutions are being developed. For example, many companies maintain an internal network (e.g., an Intranet) that can be remotely accessed. By pre-arrangement, files can be uploaded to servers on the Intranet, so that these files can be remotely accessed by authorized users. In other proposed solutions, technologists try to create virtual Web interfaces that can provide remote access to data stored on local computer systems.

Even with these solutions, other issues may remain. For instance, the local (e.g., desktop) and remote (e.g., laptop) computer systems will typically need to use compatible software. A software upgrade on one device may necessitate a similar upgrade on the other device.

The discussion above describes some of the disadvantages associated with the conventional models for providing portability of computer system resources. Generally speaking, with conventional IT paradigms, users often may experience frustration over the difficulty, and perhaps the near impossibility, of performing certain tasks at a remote location.

Accordingly, an improvement over conventional portable computer system paradigms is desirable. Embodiments of the present invention provide such an improvement.

### DISCLOSURE OF THE INVENTION

Embodiments of the present invention pertain to methods and devices providing portability of computer resources. Profile information associated with a user is received. The profile information is for configuring a device in a configuration particular to the user. The profile information is transferable to different devices, so that the configuration is substantially reproducible on the different devices. Access to selected software resident on the device is permitted according to the profile information. Access to other selected software not resident on the device but residing on a source external to the device is also permitted according to the profile information.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of an exemplary system for providing portability of computer system resources according to one embodiment of the present invention.

FIG. 2 is a block diagram of an exemplary system for providing portability of computer system resources according to another embodiment of the present invention.

FIG. 3 is a block diagram of a device upon which embodiments of the present invention may be implemented.

FIG. 4 is a logical representation of a memory in the device of FIG. 3 according to one embodiment of the present invention.

FIG. 5 is a flowchart of a method for providing portability of computer resources according to one embodiment of the present invention.

FIG. 6 is a data flow diagram showing the flow of information through an exemplary system for providing computer system resources according to one embodiment of the present invention.

FIG. 7 is a data flow diagram showing the flow of information through an exemplary system for providing computer system resources according to other embodiments of the present invention.

FIG. 8 is a flowchart of a method for utilizing profile information according to one embodiment of the present invention.

FIG. 9 outlines the contents of a personal profile according to one embodiment of the present invention.

The drawings referred to in this description should not be understood as being drawn to scale except if specifically noted.

### BEST MODE FOR CARRYING OUT THE INVENTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of the present invention, numerous specific details are set forth in order to provide a thorough understanding of the present invention. In other instances, well-known methods, procedures, components, and circuits have not been described in detail as not to unnecessarily obscure aspects of the present invention.

As an overview, embodiments of the present invention pertain to methods and devices that, in essence, provide services for hosting computer system resources. Generally speaking, according to one embodiment, ubiquitous hardware and software platforms (terminals or nodes) are made available to users. By virtue of a personal profile that is either carried with a user (e.g., as a compact disk) and/or accessed from a centralized source (e.g., via the Internet), these nodes are readily and sufficiently configured to provide to the user a computer system that is substantially reproduced from node to node. At each node, changes to the user's personal profile can be captured and reproduced at the next node. Thus, for example, under some circumstances, the user may not need to “own” a computer system, but instead can reproduce a virtual computer system at each node. According to its various embodiments, the present invention is substantially equivalent to a highly portable computer system that also provides the advantages and features of desktop computer systems. In addition, as will be seen, embodiments of the present invention also effectively address the issue of gaining remote access to local memory.

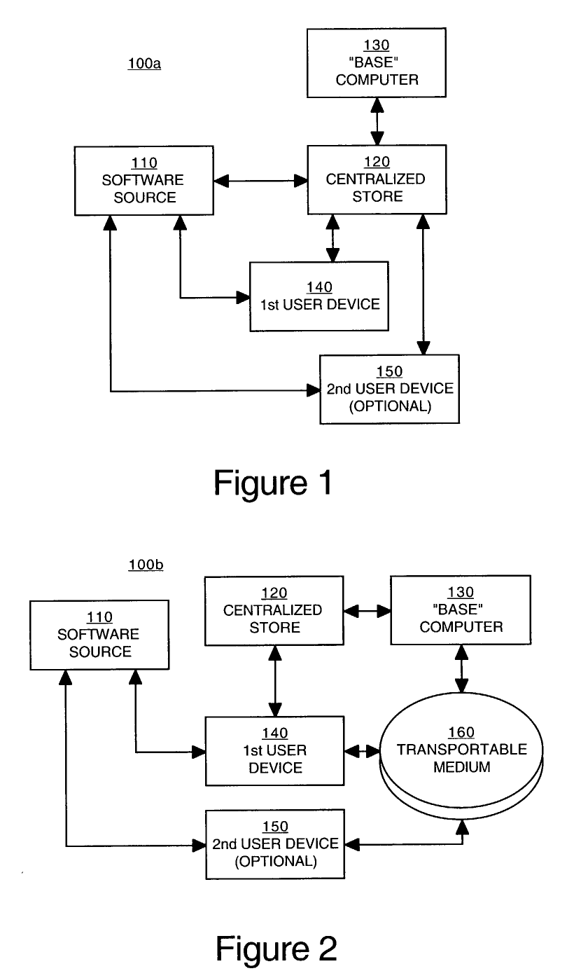

FIG. 1 is a block diagram of an exemplary system 100a for providing portability of computer system resources according to one embodiment of the present invention. In this embodiment, system 100a includes a software source 110, a centralized store 120, a “base” computer 130, a first user device 140, and an optional second user device 150. It is appreciated that system 100a may include elements other than those shown. System 100a may also include more than one of the various elements that are shown. The functionality of each of these elements is discussed below; it is appreciated that these elements may implement functionality other than that discussed. It is also appreciated that the functionality provided by multiple elements may be combined in a single element. For example, centralized store 120 may also serve as a source of software.

In the present embodiment, the various elements of system 100a are in communication with each other as illustrated. That is, in the present embodiment, base computer 130 communicates with centralized store 120; centralized store 120 also communicates with software source 110 and user devices 140 and 150; and user devices 140 and 150 also communicate with software source 110. Such communication may occur directly between elements, or indirectly through an intermediary device or node. Also, such communication may be wired or wireless, or a combination of wired and wireless. In one embodiment, communication occurs over the World Wide Web (or Internet).

In the present embodiment, software source 110 represents a provider (e.g., vendor) or repository of software and software services. For example, software source 110 may be a source of word processing applications, or might provide services related to word processing. Generally speaking, software source 110 also provides a measure of control over whom or what (e.g., a user or a device) can access software under control of software source 110. That is, for example, software source 110 may execute some type of authentication scheme to make sure that access to software is only provided to those authorized to have access. This can be accomplished in a variety of different ways. One way is for the software provider to implement a function for authenticating and tracking registered users via personalized (and unique) user information such as a name and social security number. Another way is for a unique key to be assigned to each user's personal profile, in which case a software application (or a software application key) would only be usable if used in conjunction with a proper profile key.

In the present embodiment, user devices 140 and 150 are hardware/software platforms (or nodes or terminals) that are available to users. The devices 140 and 150 may be freely available to users, they may be made available to users on a fee basis, or they may be provided to users as an inducement related to another type of free or fee-based service. For example, devices 140 and 150 could be located in hotel rooms or other locations frequented by travelers, who might be expected to make up a significant portion of those individuals desiring portable computer system resources. As will be seen, devices 140 and 150 can also provide advantages when located in homes and offices.

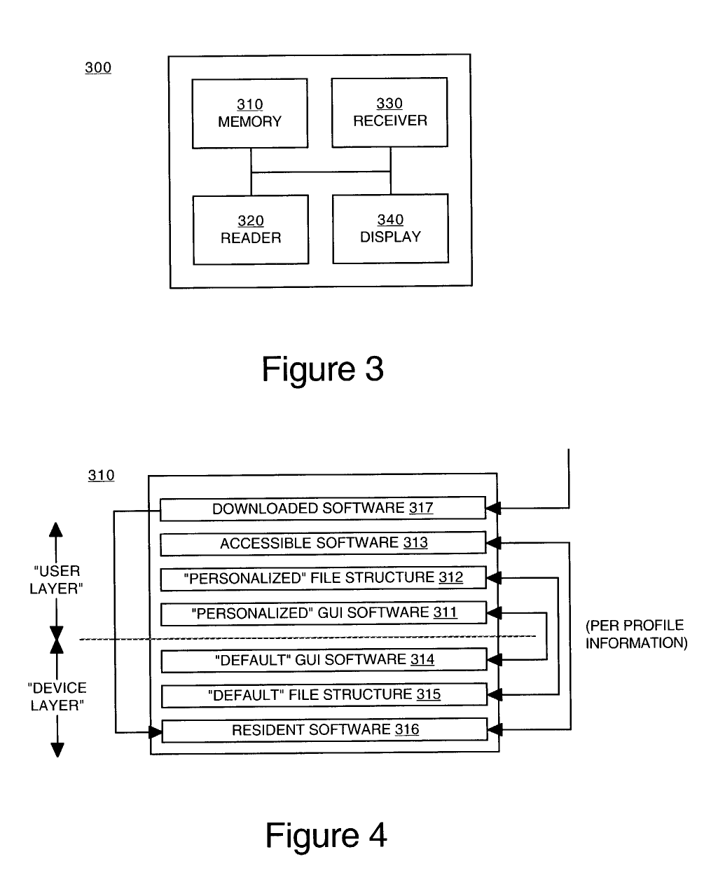

An embodiment of user device 140 or 150 is described further in conjunction with FIG. 3, below. User device 140 or 150 may be a computer system (such as a laptop, desktop or notebook), a hand-held device (such as a personal digital assistant), a cell phone, or another type of device that, in general, provides the capability for users to access and execute software including computer-usable applications and computer-readable files. User device 150 may be the same type of device as device 140, or a different type of device.

Software needed or requested by a user of device 140 or 150 may or may not be resident on device 140 or 150. If the software is resident on the device 140 or 150, access to the software can be provided if the user is authorized to use the software. If the software is not resident on device 140 and/or 150, and if the user is authorized to use the software, it may be accessed (and perhaps retrieved) from software source 110 (or perhaps central store 120). That is, for example, software that is frequently requested by users may be stored on devices 140 and/or 150, while software that is less frequently requested can be accessed and/or retrieved from software source 110.

A distinction is made herein between “accessed” and “retrieved.” For instance, in high bandwidth networks, information may be streamed back and forth between nodes at a rate that satisfactorily allows applications to be remotely executed. Thus, for example, a user may input information at device 140; the user input is sent to software source 110 for execution; and the results are returned to device 140. Similarly, in high bandwidth networks, instances of software may be downloaded quickly, and so it may not be necessary to store all instances of software on devices 140 and 150. Instead, instances of software are downloaded from software source 110 to device 140 or 150 when needed (e.g., requested), but are not stored on device 140 or 150.

Also, a memory management scheme or protocol can be utilized by devices 140 and 150 to decide what software should be stored thereon, particularly should an instance arise in which these devices run short of memory capacity. For example, devices 140 and 150 can rank instances of software according to their frequencies of use, and purge the least used instance(s) in order to make room for another instance of software. Alternatively, it may be more desirable to purge a number of smaller instances of software rather than a single larger one, regardless of the relative frequencies of use. Other memory management schemes may be used.

Furthermore, in cases in which an instance of software is to be downloaded to device 140 or 150, in one embodiment the software is configured according to the attributes of the user device. For example, should user device 140 be a desktop computer system, the download could include the full version of the instance of software. However, should user device 140 be a device having comparatively fewer computational resources, than a limited version of the instance of software, or a version tailored for the particular type of device, can be downloaded instead.

In the present embodiment, one of the functions of centralized store 120 of FIG. 1 is to provide a remotely accessible storage device. Another function of centralized store 120 may be as a mail server, in order to provide electronic mail (e-mail) service to users via devices 140 and 150.

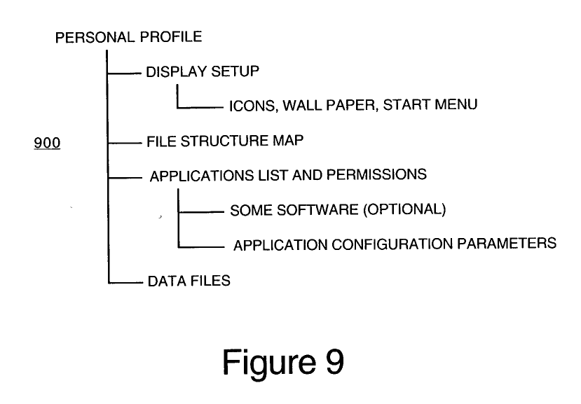

Significantly, in the present embodiment, centralized store 120 includes user-specific “profile information.” This profile information may include a variety of different types of information associated with a particular user. The contents of the profile information according to one embodiment of the present invention are described in conjunction with FIG. 9, below. In one embodiment, centralized store 120 stores, for example, personalized data files for each individual user. Such personalized files may include, for example, a word processing file (e.g., a document) created by a user (specifically, a file created by an application in response to user input).

In another embodiment, the profile information stored by centralized store 120 includes permission information indicating, for example, which software applications the user is authorized to access and use. In one such embodiment, centralized store 120 also stores the software applications that each individual user is authorized to use. This may include all of the software applications that a particular user is authorized to use, or a subset of those applications.

Note that, when a user has authorization to use an application, it is understood that such authorization may be limited with respect to the version of the application, the features of the application, or the like. That is, for example, a user may be authorized to use an earlier version of an application, but not the most recent release of the application.

In yet another embodiment, the profile information includes information uniquely identifying the user, and may include authentication parameters for authenticating the user's identity. These latter features can be used to prevent someone from duplicating the profile information, thereby preventing unauthorized access to another user's personal information, and also limiting access to applications to only those users that have license to use those applications. In general, the profile information can include information for securing the profile information, to protect the rights and privileges of users as well as application/service providers. In one embodiment, the profile information is encrypted.

In yet another embodiment of the present invention, the profile information includes parameters that are used to configure user device 140 or 150 according to the user's preferences while the device is in use by the user. In one such embodiment, the profile information includes display parameters. Using these display parameters, a graphical user interface can be provided on device 140 or 150 that is essentially replicated from node to node, providing the user with a familiar interface at each node. In another such embodiment, the profile information includes a definition of the file structure (e.g., directories, folders, etc.) employed by the user. In this latter embodiment, the file structure existing on device 140 or 150 can be mapped to the file structure defined for the user in the profile information.

Thus, for example, if the user has a preference for particular graphical elements (e.g., icons) to be displayed on a device's “desktop” display, or prefers that the elements be arranged in a particular manner on the desktop display, the graphical user interface provided by device 140 or 150 will reflect those preferences while the device is being used by the user. Also, for example, if the user prefers to put word processing documents in a particular folder in the file structure, or expects software to be located in a particular directory in the file structure, these preferences will also be reflected on device 140 or 150 while the device is being used by the user. Of significance, according to the embodiments of the present invention, devices 140 and 150 can be configured one way for one user, and another way for the next user.

In one more embodiment of the present invention, the profile information includes parameters that can be used to configure software resident on, downloaded to, or accessed by device 140 or 150. For instance, the profile information can include default settings and other user preferences utilized by a word processing application, so that this application is configured according to the user's preferences at each of the nodes.

In each of the various embodiments of the present invention, the profile information can be updated as appropriate. Thus, changes made to the profile information—including changes to personalized data files, changes made to user preferences, etc.—can be captured and reflected the next time the user employs device 140 or 150.

In one embodiment, during the creation of the user's profile information, either a file itself or a pointer to the file may be included in the profile information. The file itself may be used for user-specific files such as personalized data files (e.g., a word processing file). Pointers to files can be used for files that are more generally used and thus may be available from a remote device such as centralized source 120. Subsequently, the pointers can be replaced with a copy of the pertinent file.

Continuing with reference to FIG. 1, in the present embodiment, “base” computer 130 is an optional device. “Base” is used herein to refer to a computer system that may be located in a user's home or office, for example. A user may utilize base computer 130 to define the standards and preferences that constitute the user's profile information. In one embodiment, the user's preferences are automatically recorded and maintained as part of the profile information. That is, the user does not necessarily have to perform deliberate actions, beyond his or her normal activities, to establish or maintain a user profile. Instead, the user utilizes base computer 130 in a relatively familiar fashion, and the user's actions, selections and preferences that are used to configure (e.g., personalize) the base computer 130 are automatically recorded in the profile information. Thus, in one embodiment, by configuring and/or reconfiguring his or her “base” device, the user automatically creates (and updates) the profile information that can be used to configure another device (e.g., device 140 or 150).

In the present embodiment, device 140 or 150 is used to substantially reproduce the “look and feel” of base computer 130. For example, device 140 or 150 may be an unfamiliar machine, such as a device located in a hotel room. After configuration according to the profile information, the unfamiliar device will take on the appearance and functionality of a device familiar to the user.

It is appreciated that a user's profile information can be established and maintained, automatically or otherwise, using any of the devices 140 and 150. In this latter case, the user does not need to own (or lease, etc.) a computer; instead, a “virtual” computer is created, existing via the profile information and actualized on devices 140 and 150. As such, the device at the user's home or office (e.g., base computer 130) may be similar to devices 140 and 150 in design and functionality.

FIG. 2 is a block diagram of an exemplary system 100b for providing portability of computer system resources according to one embodiment of the present invention. The embodiment of FIG. 2 has some similarity to the embodiment of FIG. 1. One distinction between system 100b of FIG. 2 and system 100a of FIG. 1 is that the profile information resides on a transportable, computer-readable medium 160, such as a compact disk (CD) or a digital video disk (DVD), instead of in a centralized store 120. As the memory capacity of CDs, DVDs, and the like increases, these types of storage media can be used to store much of, if not all of, the profile information that might be stored using centralized store 120.

It is appreciated that some combination of the systems 100a and 100b may be used. For example, profile information including the user's preferences may be stored on transportable medium 160, while data files (e.g., word processing documents) may be stored on centralized store 120. As such, information analogous to the type of information that is conventionally stored on the hard drive of a local computer system can be readily accessed from remote locations.

In one embodiment, instead of the totality of profile information being stored on transportable medium 160, a pointer (e.g., a Uniform Resource Locator) that points to a location of the profile information is stored on transportable medium 160. For example, the profile information may be stored in a location on centralized store 120, with a pointer to that location provided by transportable medium 160. In one such embodiment, the transportable medium 160 also includes authentication information or the like that provides a measure for controlling who has access to the profile information stored at centralized store 120.

With reference to FIGS. 1 and 2, use of the present invention (in its various embodiments) is illustrated by way of the following example. Initially, an individual creates profile information using one of the user devices 140 or 150 or, optionally, base computer 130. For the sake of the example, the user will be said to have utilized device 140 to create the profile information. Note that, as described above, the profile information may be created automatically in concert with the user's actions.

In the present embodiment, the profile information is stored using either centralized store 120 or transportable medium 160, or a combination thereof. Subsequently, the profile information is utilized by the user in another of the devices 130, 140 or 150. For the sake of the example, the user will be said to be using device 150.

Continuing with the example, device 150 receives the profile information from either centralized store 120 or medium 160, or from a combination thereof. Device 150 then configures itself according to the profile information. For example, device 150 generates a graphical user interface that is substantially the same as that which existed on device 140 when the profile information was created. Also, device 150 presents to the user a file structure according to the profile information, emulating the file structure defined by the user in the profile information. As described above, in one embodiment, the profile information includes a definition of the file structure (e.g., directories, folders, etc.) employed by the user, and the file structure existing on device 150 can be mapped to the file structure defined by/for the user in the profile information.

In the present embodiment, access to selected software resident on device 150 (sometimes referred to herein as “first software”) is permitted according to the profile information (specifically, according to permission information provided by the profile information). Software not resident on device 150 (sometimes referred to herein as “second software”) can be accessed and/or retrieved from software source 110, if the profile information indicates that the user is authorized to use such software. In one embodiment, permission information provided by the profile information is provided to software source 110 for authentication.

In the present embodiment, the first software and the second software are configured according to parameters provided by the profile information. Therefore, device 150 is configured essentially the same as device 140, both in “look” and “feel.”

Once the user completes his/her session on device 150, the results of any activities performed during the session can be saved to centralized store 120 and/or to transportable medium 160. In one embodiment, device 150 implements a logging function that, for example, tracks the user's actions and what the user works on. In one such embodiment, the profile information is then updated accordingly when the user closes an application or logs off. In another such embodiment, the user is queried to determine whether the user wants to save changes to the profile information. The user may also selectively save changes to the local device memory, should that be advantageous; for example, the user may want to save changes to a device that is frequently utilized. As will be described, even when the device is not a device “owned” by the user, the user's information can be retained in a device layer that is not accessible by other users (refer to FIG. 4, below).

In general, the present invention, in various embodiments, overwrites the original or preceding version or state (e.g., of the profile information) with a revised version generated during a session. By facilitating the saving of updates made during a session, embodiments of the present invention help ensure that a coherent version of the profile information will exist across the system 100a or 100b (FIGS. 1 and 2). This feature of coherence provides a mechanism by which the version available to the user locally (e.g., at a user device such as user device 150) will conform to a version that can be considered a “master” copy. The master copy may be stored at centralized store 120, from which it is accessible from a user device 140 or 150 (as well as base computer 130) as described above. The master copy may also be stored using transportable medium 160.

Thus, according to the embodiments of the present invention, the user's “virtual” computer system is essentially again reproduced in a subsequent session, perhaps on a completely different device. In this manner, portability of computer system resources is achieved without the use of portable devices such as laptops, notebooks, personal digital assistants, cell phones, and the like. In addition, access to stored information is facilitated. In essence, centralized source 120 and/or transportable medium 160 provide the functionality of a hard drive, so the issue of gaining remote access to local memory is effectively addressed in accordance with the various embodiments of the present invention.

It is appreciated that systems 100a and 100b of FIGS. 1 and 2, respectively, may be utilized for purposes other than those described in the above example. For instance, advertisements and other information that may be of interest can be directed to users over systems 100a and 100b.

FIG. 3 is a block diagram of a device 300 (e.g., computer system 130 or user device 140 or 150 of FIGS. 1 and 2) upon which embodiments of the present invention may be implemented. In the present embodiment, device 300 includes a memory 310, a reader 320, a receiver 330, and a display 340. It is appreciated that device 300 may include elements other than those described. For example, device 300 may include some type of processor. It is also appreciated that the functionalities provided by multiple elements may be combined into a single element; likewise, functionality provided by a single element may be implemented using multiple elements.

In the present embodiment, memory 310 is random access (e.g., volatile) memory (RAM) for storing information, such as the types of information described above. Memory 310 is described further in conjunction with FIG. 4, below. Device 300 may also include read only (non-volatile) memory (ROM).

In the present embodiment, reader 320 is a device that can be used to read computer-readable media, such as transportable medium 160 of FIG. 2. Reader 320 can also have the capability to write information to computer-readable media. In one embodiment, reader 320 is employed to receive information sufficient to cause the device 300 to access and load profile information, for example, from centralized store 120 (FIG. 1).

Receiver 330 of FIG. 3 is a device that can be used to communicate in wired and/or wireless fashion with another device in system 100a or 100b (FIGS. 1 and 2, respectively). Receiver 330 may provide the capability to transmit as well as receive information. Display 340 is a device that can be used for displaying a graphical user interface.

FIG. 4 is a logical representation of memory 310 according to one embodiment of the present invention. Memory 310 may be utilized in base computer 130 and user devices 140 and 150 of FIGS. 1 and 2.

In the present embodiment, the memory 310 of FIG. 4 can be considered as having a “user layer” and a “device layer.” The device layer can be considered as having software (e.g., applications and files) such as “default” graphical user interface (GUI) software 314, “default” file structure 315, and resident software 316. The user layer can be considered as having software such as “personalized” GUI software 311, “personalized” file structure 312, and accessible software 313. It is appreciated that elements of the user layer may be implemented using elements of the device layer, as will be described further below. It is also appreciated that the contents of memory 310 may not actually be partitioned as illustrated by FIG. 4. The contents of memory 310 are illustrated as different blocks to facilitate the description of certain features of the present invention.

According to the present embodiment, the default GUI software 314 is for generating a graphical user interface used by device 140 or 150 (FIGS. 1 and 2) in the absence of profile information. The default file structure 315 is the file structure used by device 140 or 150 in the absence of profile information. The resident software 316 is the software that is stored on device 140 or 150. In one embodiment, as described above, a memory management scheme or protocol is used to determine which instances of software are stored in memory 310, particularly in case of reduced memory capacity.

Access to the resident software 316 of FIG. 4 is controlled by device 300 (FIG. 3). As described above, device 300 uses the profile information (specifically, permission information associated with the profile information) to identify and authenticate which instances of the resident software 316 a user is authorized to access.

In the present embodiment, the user layer is in essence inserted as another tier “above” the device layer, essentially insulating the device layer (specifically, its contents) from a user. As such, the user may be prevented from gaining access to and/or altering the contents of the device layer, preserving this information for the next user.

Instead, according to the present embodiment, the contents of the user layer are used to configure a device (e.g., device 140 or 150 of FIGS. 1 and 2) according to the profile information associated with a user. Personalized GUI software 311 may be a copy of the default GUI software 314, but customized with the display parameters provided by the profile information in order to provide a graphical user interface that is personalized for the user. Alternatively, the display parameters may be used by default GUI software 314 to provide the personalized graphical user interface.

In the present embodiment, with reference to FIG. 4, a personalized file structure 312 is provided by the profile information associated with the user. In addition, the personalized file structure 312 may be mapped to the default file structure 315.

According to the present embodiment, accessible software 313 includes the software resident on the device 140 or 150 (FIGS. 1 and 2) that the user has permission to access according to the user's profile information. The accessible software 313 may include a copy of selected software from resident software 316, or access may simply be provided to selected instances of resident software 316, according to the profile information.

In the present embodiment, memory 310 of FIG. 4 can also include downloaded software 317. The downloaded software 317 includes the software to which the user has access privileges, but which was not resident on the device 140 or 150. As mentioned above, the downloaded software 317 can be retrieved from software source 110 or perhaps from central store 120 of FIGS. 1 and 2, or perhaps from transportable medium 160 of FIG. 2. The downloaded software 317 may be added to resident software 316, depending on frequency of use, memory capacity, or other factors. As described above, a memory management scheme may be used to arrive at a decision whether or not to store downloaded software 317 on the local device.

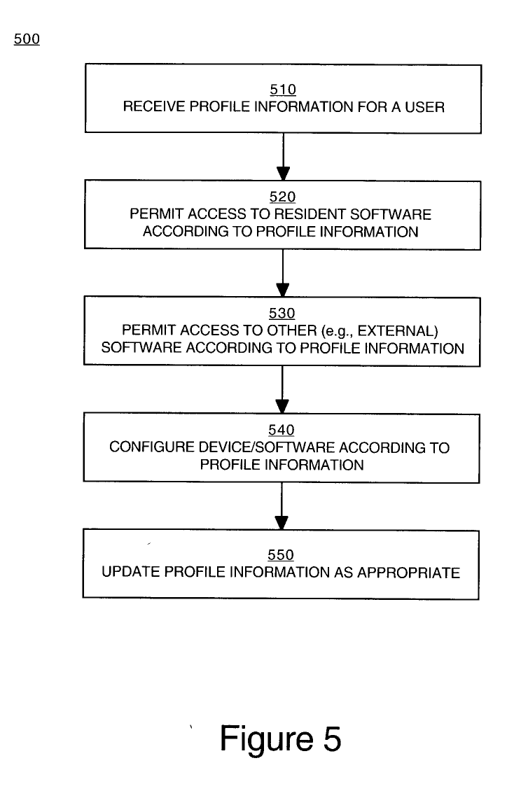

FIG. 5 is a flowchart 500 of a method for providing portability of computer resources according to one embodiment of the present invention. Although specific steps are disclosed in flowchart 500, such steps are exemplary. That is, embodiments of the present invention are well suited to performing various other steps or variations of the steps recited in flowchart 500. It is appreciated that the steps in flowchart 500 may be performed in an order different than presented, and that not all of the steps in flowchart 500 may be performed. All of, or a portion of, the methods described by flowchart 500 may be implemented using computer-readable and computer-executable instructions which reside, for example, in computer-usable media of a computer system or like device. Generally, flowchart 500 is implemented by devices such as base computer 130 or devices 140 and 150 of FIGS. 1 and 2.

In step 510 of FIG. 5, in the present embodiment, profile information associated with a user is received by a user device. The profile information is generally for configuring the device according to the preferences of the user. The profile information may also include software and software files that are associated with the user. In addition, the profile information may include identification information associated with the user, and information for authenticating the identification information (e.g., a password). The profile information can be received from a transportable medium perhaps carried by the user, or the profile information can be received from another device. In one embodiment, the profile information is received from another device via the Internet.

In step 520, in the present embodiment, access is permitted to selected software (“first software”) that is already resident on the user device when the profile information of step 510 is received. In one embodiment, the profile information includes information identifying the software to which access is permitted. In one embodiment, the permission information is sent to the source of the software (e.g., the software vendor) for authentication.

In step 530, in the present embodiment, access is established to other, selected software (“second software”) not resident on the user device. Access to the second software is permitted in accordance with the profile information (specifically, according to permission information provided by the profile information). Typically, the second software resides at a source external to the user device. In one embodiment, the second software is retrieved from the source and stored on the user device. In one such embodiment, the second software is configured according to the attributes of the user device. Memory space for any downloaded software can be allocated using a memory management scheme, in particular when memory space for the downloaded software is not available.

In step 540, in the present embodiment, the user device is configured according to the profile information of step 510. In one embodiment, a particular file structure, according to the profile information, is implemented. In another embodiment, a particular graphical user interface, according to the profile information, is provided. In yet another embodiment, the first software and the second software are configured according to the profile information.

In step 550, in the present embodiment, the profile information is updated as appropriate, either during or at the end of an ongoing user session. In this manner, updated profile information may be transferred to a subsequent user device, and the process of flowchart 500 can be repeated.

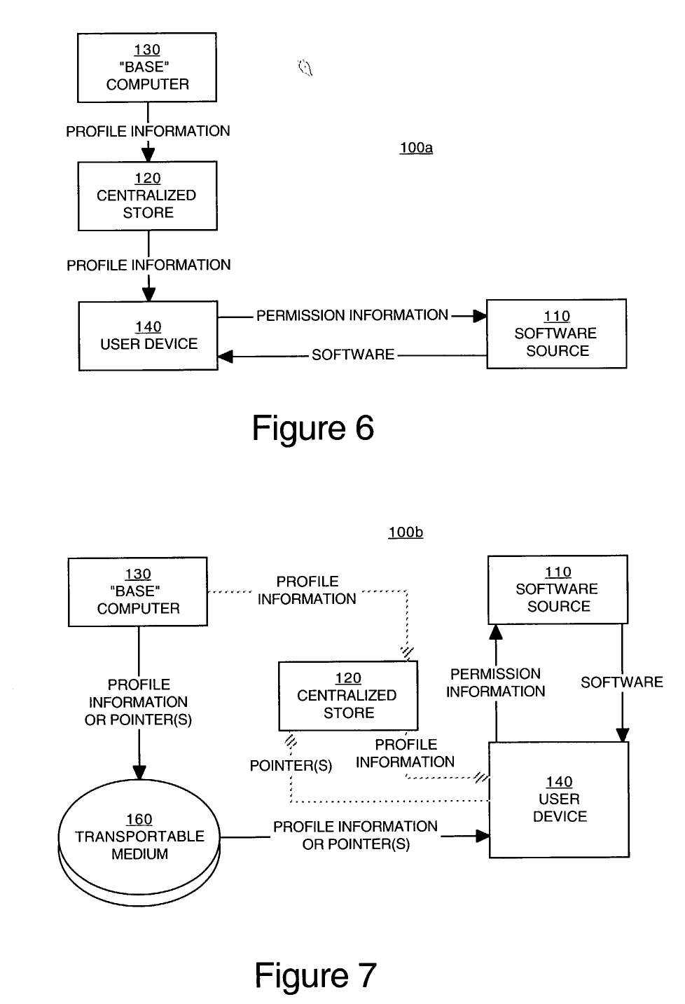

FIG. 6 is a data flow diagram showing the flow of information through an exemplary system 100a for providing computer system resources according to one embodiment of the present invention. In the present embodiment, an individual creates profile information using base computer 130. Note that, in one embodiment, the profile information may be created automatically in concert with the user's actions. Note also that, as previously described herein, especially with regard to FIGS. 1 and 2 above, the profile information can be created on a device other than base computer 130 (e.g., devices 140 or 150 of FIGS. 1 and 2).

In the present embodiment, with reference to FIG. 6, the profile information is stored at centralized store 120. Subsequently, the user decides to use device 140. Accordingly, device 140 receives the profile information from centralized store 120. Device 140 then configures itself according to the profile information, as described previously herein.

In the present embodiment, access to selected software resident on device 140 is permitted according to the profile information. Software not resident on device 140 can be accessed and/or retrieved from software source 110, if the profile information indicates that the user is authorized to use such software. In the present embodiment, permission information provided by the profile information is provided to software source 110 for authentication. In one embodiment, software source 110 provides (downloads) the software to device 140. Alternatively, particularly in higher bandwidth implementations, device 140 can execute the software while the software resides at software source 110.

FIG. 7 is a data flow diagram showing the flow of information through an exemplary system 100b for providing computer system resources according to other embodiments of the present invention. In the present embodiment, an individual creates profile information using base computer 130. Note that, in one embodiment, the profile information may be created automatically in concert with the user's actions. Note also that, as previously described herein, especially with regard to FIGS. 1 and 2 above, the profile information can be created on a device other than base computer 130 (e.g., devices 140 or 150 of FIGS. 1 and 2).

At least two embodiments of the present invention are illustrated and described by FIG. 7. These two embodiments can be differentiated according to whether the profile information utilizes pointers or not.

In one embodiment, the profile information is provided to centralized store 120, in a manner similar to that described above in conjunction with FIG. 6. In this embodiment, pointers to the profile information that was sent to centralized store 120 are stored on transportable medium 160. For example, centralized store 120 may store the profile information at a Web site, and the pointers may include a URL for that Web site. These pointers are then provided to user device 140. Using the pointers from user device 140, the profile information can be retrieved from centralized store 120. Device 140 can then configure itself according to the profile information as previously described herein.

In various embodiments, the pointers can be used to point to the totality of the profile information, or to a subset of that information. For example, in the latter case, pointers can be used to identify individual files or groups of files.

In another embodiment, the profile information is stored using transportable medium 160 but without the use of pointers. Subsequently, the profile information is utilized by the user in device 140. Device 140 then configures itself according to the profile information.

In the present embodiment, access to selected software resident on device 140 is permitted according to the profile information. Software not resident on device 140 can be accessed and/or retrieved from software source 110, if the profile information indicates that the user is authorized to use such software. In the present embodiment, permission information provided by the profile information is provided to software source 110 for authentication. In one embodiment, software source 110 provides (downloads) the software to device 140. Alternatively, particularly in higher bandwidth implementations, device 140 can execute the software while the software resides at software source 110.

It is appreciated that some combination of the embodiments described in conjunction with FIG. 7 may be used. It is also appreciated that the embodiments of the present invention described by FIG. 7, and the combinations thereof, may also be used in combination with the embodiments of the present invention described in conjunction with FIG. 6 above.

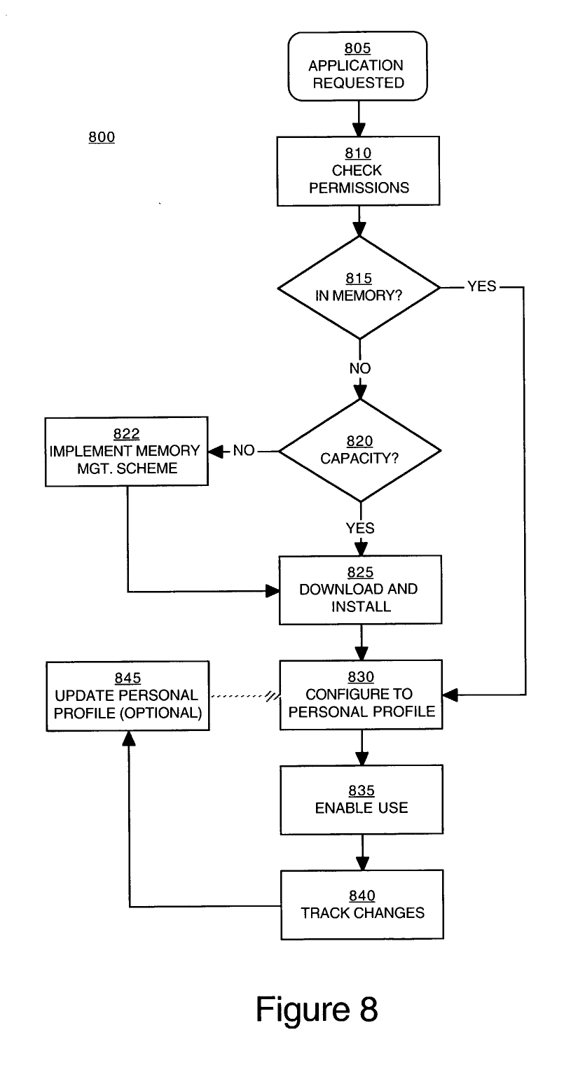

FIG. 8 is a flowchart 800 of a method for utilizing profile information according to one embodiment of the present invention. Although specific steps are disclosed in flowchart 800, such steps are exemplary. That is, embodiments of the present invention are well suited to performing various other steps or variations of the steps recited in flowchart 800. It is appreciated that the steps in flowchart 800 may be performed in an order different than presented, and that not all of the steps in flowchart 800 may be performed. All of, or a portion of, the methods described by flowchart 800 may be implemented using computer-readable and computer-executable instructions which reside, for example, in computer-usable media of a computer system or like device. Generally, flowchart 800 is implemented by devices such as base computer 130 or devices 140 and 150 of FIGS. 1 and 2. In the present embodiment, flowchart 800 is based on the presumption that the device 130, 140 or 150 has received, or has access to, the pertinent profile information.

In step 805 of FIG. 8, in the present embodiment, the use of a particular instance of software (e.g., an application) is requested by the device. In step 810, the permissions information provided by the profile information is checked to determine whether access to the requested application is authorized. Presuming that access to the application is permitted, flowchart 800 proceeds to step 815.

In step 815, in the present embodiment, a determination is made as to whether or not the requested application is resident in local memory (e.g., resident software 316 of FIG. 4). If so, then flowchart 800 proceeds to step 830; otherwise, flowchart 800 proceeds to step 820.

As described above, when software is not resident on the local device, in one embodiment the software can be downloaded from a software source and stored on the local device. In step 820 of FIG. 8, in the present embodiment, a determination is made with regard to whether or not there is sufficient memory available to store the requested application.

If there is not sufficient capacity, then a memory management scheme is implemented to identify one or more other instances of software that can be removed from memory in order to create room for the application to be downloaded (step 822). Any of various memory management schemes known in the art may be used in this event. These memory management schemes include least recently used (LRU) schemes, least frequently used (LFU) schemes, LRU-K schemes, GreedyDual (GD) schemes, and the like.

With sufficient memory capacity, flowchart 800 proceeds to step 825. In step 825, according to the present embodiment, the requested software application is downloaded from the software source. As described above, the software source may use the permissions information provided by the profile information, or some other mechanism of choice, to authenticate that access to the requested software is permissible.

In step 830, in the present embodiment, the software application is configured according to the profile information, as previously described herein. In step 835, use of the software application can now occur.

In step 840, in the present embodiment, a logging function is implemented that, for example, tracks the user's actions and what the user works on. In step 845, in one embodiment, the profile information is then updated accordingly when the user closes the application or logs off. In another embodiment, the user is queried to determine whether the user wants to save changes to the profile information. Note that the user may also selectively save changes to the local device memory. Also, once the user completes his/her session, the update profile information can be saved to centralized store 120 and/or to transportable medium 160 (FIGS. 1 and 2).

FIG. 9 outlines the contents of profile information 900 according to one embodiment of the present invention. In this embodiment, profile information 900 includes information for a display setup, file structure map, applications list and permissions, and data files. The display setup may include the icons and wall paper to be displayed, and the items to be included in the start menu. The file structure mapping is described above in conjunction with FIG. 4. The applications list may include some software; other software is either resident on the local device or can be retrieved or accessed from a software source. User-specific (e.g., personal) data files may also be included in the profile information 900. It is appreciated that profile information 900 can also include other information.

In summary, embodiments of the present invention pertain to methods and devices that, in essence, provide services for hosting computer system resources. Generally speaking, a user actualizes a virtual computer system at each device. According to its various embodiments, the present invention is substantially equivalent to a highly portable computer system that also provides the advantages and features of desktop computer systems. In addition, embodiments of the present invention also effectively address the issue of gaining remote access to local memory.

Embodiments of the present invention are thus described. While the present invention has been described in particular embodiments, it should be appreciated that the present invention should not be construed as limited by such embodiments, but rather construed according to the following claims.

What is claimed is:

1. A method for providing portability of computer resources, said method comprising:
receiving profile information associated with a user, wherein said profile information is for configuring a user device in a configuration particular to said user, wherein said profile information is transferable to different user devices and wherein said configuration is substantially reproducible on said different user devices;
permitting access to first software resident on said user device, said first software selected according to said profile information; and
establishing access to second software not resident on said user device, said second software residing on a source external to said user device, said second software selected according to said profile information.

2. The method of claim 1 wherein said profile information is stored on a computer-readable medium transportable between said different user devices.

3. The method of claim 1 wherein said profile information is stored on another device accessible by said user device via the Internet.

4. The method of claim 1 wherein said profile information comprises permission information for identifying software that said user is authorized to use.

5. The method of claim 4 further comprising:
sending said permission information to said source for authentication.

6. The method of claim 1 further comprising:
organizing computer-readable files in memory on said user device in a particular file structure according to said profile information.

7. The method of claim 1 further comprising:
arranging a graphical user interface on said user device according to said profile information.

8. The method of claim 1 wherein said second software is configured according to attributes of said user device.

9. The method of claim 1 further comprising:
configuring said first and second software according to said profile information.

10. The method of claim 1 wherein said profile information is encrypted.

11. The method of claim 1 wherein said profile information comprises computer-readable files associated with said user, said computer-readable files comprising personalized files generated according to input from said user.

12. The method of claim 1 further comprising:
retrieving said second software from said source; and
allocating memory space on said user device using a memory management scheme, wherein information is removed from memory according to said memory management scheme when memory space for said second software is unavailable.

13. The method of claim 1 wherein said user device and said source communicate via the Internet.

14. The method of claim 1 further comprising:
updating said profile information.

15. A device comprising:
a memory having first software stored therein;
a receiver coupled to said memory, said receiver for accessing second software stored remotely; and
a display device coupled to said memory;
wherein said device is configured in a configuration particular to a user according to profile information, wherein said profile information is transferable to different devices and wherein said configuration is substantially reproducible on said different devices;
said profile information comprising permission information for identifying which of said first software and said second software said user is permitted to use.

16. The device of claim 15 comprising a reader element coupled to said memory, said reader element for reading computer-readable media, wherein said profile information is stored on a computer-readable medium transportable between said different user devices.

17. The device of claim 15 wherein said profile information is stored on another device accessible by said device via said receiver.

18. The device of claim 17 comprising a reader element coupled to said memory, said reader element for reading a computer-readable medium that comprises a pointer identifying a location of said profile information.

19. The device of claim 17 wherein said receiver is adapted for communication via the Internet.

20. The device of claim 15 wherein said permission information is authenticated by a provider of said second software.

21. The device of claim 15 wherein computer-readable files in said memory are mapped to a file structure defined according to said profile information.

22. The device of claim 15 wherein said display device is adapted to display a graphical user interface comprising graphics elements arranged according to said profile information.

23. The device of claim 15 wherein instances of said first and second software that are accessible according to said profile information are configured according to said profile information.

24. The device of claim 15 wherein said profile information is encrypted.

25. The device of claim 15 wherein said profile information comprises computer-readable files associated with said user, said computer-readable files comprising data files generated according to input from said user.

26. The device of claim 15 wherein an instance of said second software is retrieved from said source, stored in said memory, and configured according to attributes of said user device.

27. The device of claim 26 wherein information is removed from said memory according to a memory management scheme when memory space for said instance of second software is unavailable.

28. A computer-readable medium having computer-readable code stored thereon for causing a device to perform a method of hosting computer resources, said method comprising:
receiving profile information associated with a user, wherein said profile information is for configuring said device in a configuration particular to said user, wherein said profile information is transferable to different devices and wherein said configuration is substantially reproducible on said different devices;
determining from said profile information which software said user is authorized to execute, said software comprising first software resident on said device and second software not resident on said device but residing at a source accessible by said device;
permitting access to said first software; and
establishing access to said second software.

29. The computer-usable medium of claim 28 wherein said profile information is stored on a computer-readable medium transportable between said different devices.

30. The computer-usable medium of claim 28 wherein said profile information is stored on another device accessible by said device via the Internet.

31. The computer-usable medium of claim 28 wherein said profile information comprises permission information for identifying software that said user is authorized to use.

32. The computer-usable medium of claim 31 wherein said permission information is authenticated by said source.

33. The computer-usable medium of claim 28 wherein said computer-readable program code embodied therein causes a device to perform said method comprising:
storing computer-readable files in a file directory that is organized according to said profile information.

34. The computer-usable medium of claim 28 wherein said computer-readable program code embodied therein causes a device to perform said method comprising:
arranging graphic user interface elements according to said profile information.

35. The computer-usable medium of claim 28 wherein said second software is configured according to attributes of said device.

36. The computer-usable medium of claim 28 wherein said computer-readable program code embodied therein causes a device to perform said method comprising:
using said profile information to configure said first and second software.

37. The computer-usable medium of claim 28 wherein said profile information is encrypted.

38. The computer-usable medium of claim 28 wherein said profile information comprises computer-readable files associated with said user, said computer-readable files comprising data files generated according to input from said user.

39. The computer-usable medium of claim 28 wherein said computer-readable program code embodied therein causes a device to perform said method comprising:
downloading said second software from said source; and
deleting information from said memory when memory space for said second software is unavailable, said information selected according to a memory management scheme.

40. The computer-usable medium of claim 28 wherein said device and said source communicate via the Internet.

41. The computer-usable medium of claim 28 wherein said computer-readable program code embodied therein causes a device to perform said method comprising:
updating said profile information.

42. The computer-usable medium of claim 28 wherein said computer-readable program code embodied therein causes a device to perform said method comprising:
receiving identification information that is specific to said user; and
authenticating said identification information.
